(19) United States
(12) Patent Application Publication
(10) Pub. No.: US 2022/0083973 A1
(43) Pub. Date: Mar. 17, 2022

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Masamichi TANABE, Tokyo (JP); Shinichiro SATO, Tokyo (JP); Takahiro MATSUI, Tokyo (JP)

(73) Assignee: NEC Corporation, Minato-ku, Tokyo (JP)

(21) Appl. No.: 17/423,357

(22) PCT Filed: Mar. 3, 2020
(86) PCT No.: PCT/JP2020/008971

§ 371 Date: Jul. 15, 2021

(30) Foreign Application Priority Data
Mar. 22, 2019 (JP) 2019-054691

(51) Int. Cl. G06Q 10/08; G06Q 20/20

(52) U.S. Cl. CPC G06Q 10/0875; G06Q 20/203

(57) ABSTRACT

An information processing device of a child store communicably connected to a mother store terminal of a mother store according to an aspect of the present disclosure includes: at least one memory configured to store instructions; and at least one processor configured to execute the instructions to: acquire an item ID and an item quantity of an item input by a customer at the child store; generate an item request based on the item ID, the item quantity, and an item stock in the child store; transmit the item request to the mother store terminal; receive, from the mother store terminal, replenishment date and time of the item, determined based on the item request and an item stock in the mother store; and output the replenishment date and time of the item.

### TECHNICAL FIELD

The present disclosure relates to an information processing device and the like.

### BACKGROUND ART

A store operation, in which convenience for customers is improved and store opening cost is reduced by having a small child store such as an in-office convenience store near a mother store, has been introduced. It is important to notify a customer of the possibility that an item short in stock will be replenished in the store in order to make them conscious of coming back to the store and reduce the opportunity loss of the sales of the store.

PTL 1 discloses a technology for informing a customer having ordered an item from a vending machine of the arrival time of the ordered item. More specifically, a customer orders an item from a vending machine, and order information is sent to a mobile terminal of a traveling worker who replenishes the vending machine with the item. When the traveling worker inputs, to the mobile terminal, the replenishment time of the item for the vending machine, the replenishment time of the ordered item is transmitted to the vending machine.

### CITATION LIST

### Patent Literature

[PTL 1] JP 2002-109625 A

### SUMMARY OF INVENTION

### Technical Problem

PTL 1 discloses a technology of a vending machine for notifying a customer of the arrival time of the ordered item; however, it does not disclose a technology for informing item replenishment in consideration of the item stock in the store with respect to the item that the customer wants to purchase and its quantity.

In order to solve the above problem, an object of the present disclosure is to provide an information processing device and the like for notifying item replenishment in consideration of the item stock in a store with respect to the item that the customer wants to purchase and its quantity.

### Solution to Problem

An information processing device of an aspect of the present disclosure is an information processing device of a child store that is communicably connected to a mother store terminal of a mother store, and the information processing device includes: an item information acquisition unit that acquires an item identifier (ID) and an item quantity of an item input by a customer at the child store; a request unit that generates an item request based on the item ID, the item quantity, and an item stock in the child store and transmits the item request to the mother store terminal; and an output unit that receives, from the mother store terminal, and outputs replenishment date and time of the item based on the item request and an item stock in the mother store.

An information processing method of an aspect of the present disclosure is an information processing method of an information processing device of a child store communicably connected to a mother store terminal of a mother store, and the information processing method includes: acquiring an item ID and an item quantity of an item input by a customer at the child store; generating an item request based on the item ID, the item quantity, and an item stock in the child store and transmitting the item request to the mother store terminal; and receiving, from the mother store terminal, and outputting replenishment date and time of the item based on the item request and an item stock in the mother store.

A program stored in a recording medium of an aspect of the present disclosure is a program of an information processing device of a child store communicably connected to a mother store terminal of a mother store, and the program causes the information processing device to function as: an item information acquisition unit that acquires an item ID and an item quantity of an item input by a customer at the child store; a request unit that generates an item request based on the item ID, the item quantity, and an item stock in the child store and transmits the item request to the mother store terminal; and an output unit that receives, from the mother store terminal, and outputs replenishment date and time of the item based on the item request and an item stock in the mother store.

### Advantageous Effects of Invention

According to the present disclosure, it is possible to notify item replenishment in consideration of the item stock in another store with respect to the item that the customer wants to purchase and its quantity.

### BRIEF DESCRIPTION OF DRAWINGS

FIG. 1 is a diagram illustrating an outline of an information processing system according to a first example embodiment.

FIG. 2 is a block diagram illustrating an example of a configuration of an information processing device according to the first example embodiment.

FIG. 3A is a diagram illustrating an outline of a mother store terminal according to the first example embodiment.

FIG. 3B is a block diagram illustrating an example of a configuration of the mother store terminal according to the first example embodiment.

FIG. 4 is a sequence diagram illustrating an example of an operation of the information processing system according to the first example embodiment.

FIG. 5 is a view illustrating an example of an input screen on which a customer inputs an item and its quantity.

FIG. 6 is a flowchart illustrating step S104 of an operation of the information processing device according to the first example embodiment.

FIG. 7 is a diagram illustrating an outline of an information processing system according to a second example embodiment.

FIG. 8 is a block diagram illustrating an example of a configuration of an information processing device according to the second example embodiment.

FIG. 9 is a sequence diagram illustrating an example of an operation of the information processing system according to the second example embodiment.

FIG. 10 is a flowchart illustrating step S204 of an operation of the information processing device according to the second example embodiment.

FIG. 11 is a diagram illustrating a hardware configuration of a computer.

### EXAMPLE EMBODIMENT

### First Example Embodiment

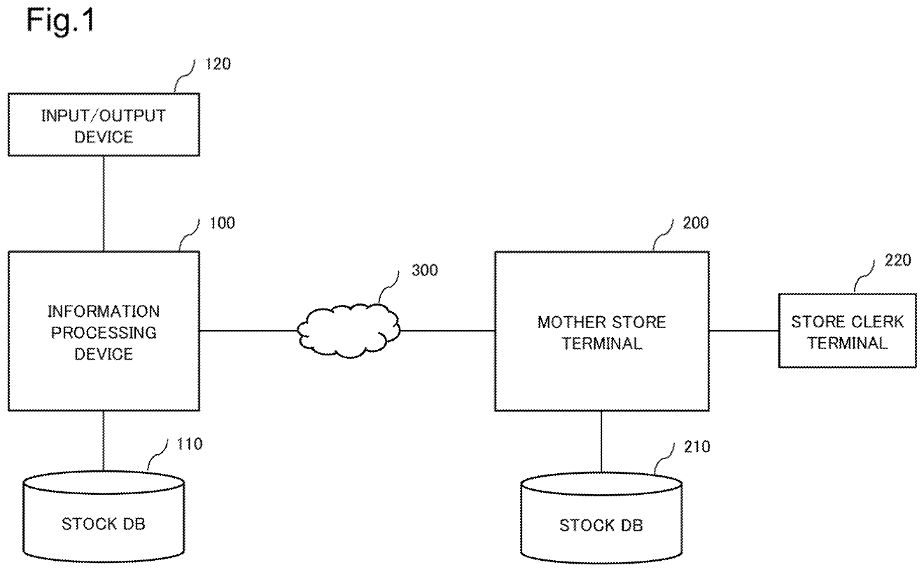

The drawings will be described regarding the information processing device according to the first example embodiment. FIG. 1 is a diagram illustrating an outline of the information processing system to which the information processing device according to the first example embodiment is applied. The information processing system illustrated in FIG. 1 includes an information processing device 100, a stock database (DB) 110, an input/output device 120, a mother store terminal 200, a stock DB 210, and a store clerk terminal 220. The information processing device 100 and the mother store terminal 200 are communicably connected via a network 300.

The stock DB 110 is connected to the information processing device 100 and stores the item stock in a child store. The stock DB 210 is connected to the mother store terminal 200 and stores the item stock in a mother store. The stock DB 110 and the stock DB 210 are, for example, storage devices. The item stock in the child store includes an item ID, which is an identifier of an item, and a quantity of the item stocked in the child store (quantity of item stock). The child store is also called, for example, a manpower-saving store, a satellite store, or a concession stand. The manpower-saving store includes an unmanned store. The item stock in the mother store includes an item ID, which is an identifier of an item, and a quantity of the item stocked in the mother store (quantity of item stock).

The input/output device 120 receives an item that a customer wants to purchase at a child store and its quantity. The input/output device 120 is, for example, a touchscreen display in which an item and its quantity are displayed on a screen in a selectable manner. The item displayed on the screen is associated with an item ID, and the information on the item and its quantity input by the customer is transmitted to the information processing device 100 as the item ID and the item quantity. The input/output device 120 may be a digital signage device or an electronic shelf label in a display shelf.

(Information Processing Device)

The information processing device 100 according to the first example embodiment generates an item request based on the item (item ID) and its quantity (item quantity) input by the customer using the input/output device 120 and the item stock in the child store, and transmits the item request to the mother store terminal 200. The configuration of the information processing device 100 will be described below.

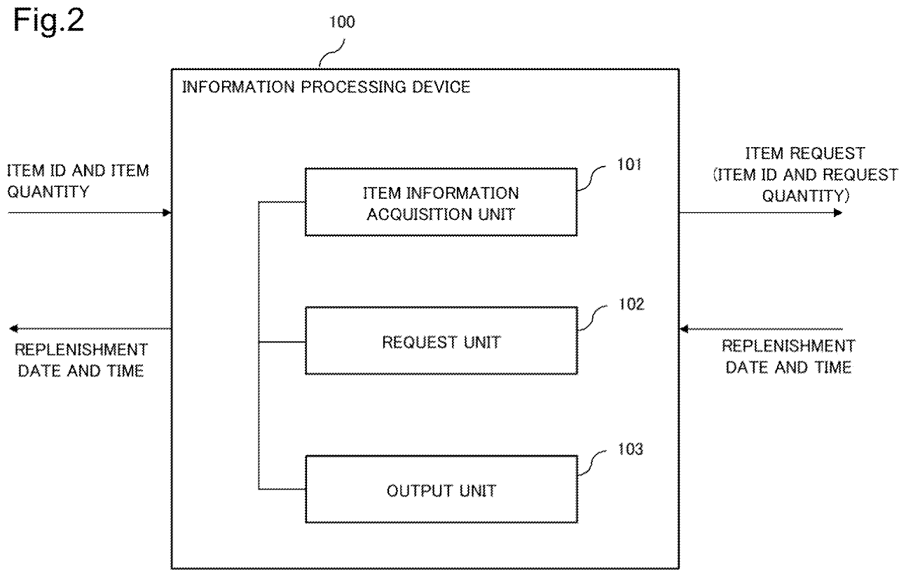

FIG. 2 is a block diagram illustrating an example of the configuration of the information processing device according to the first example embodiment. An example of the information processing device 100 is a store server of a child store. The information processing device 100 illustrated in FIG. 2 is an information processing device of the child store communicably connected to the mother store terminal 200 of the mother store, and includes an item information acquisition unit 101, a request unit 102, and an output unit 103. The item information acquisition unit 101 acquires the item ID and the item quantity of the item input by the customer at the child store. The request unit 102 generates an item request based on the item quantity and the item stock in the child store, and transmits the item request to the mother store terminal 200. The output unit 103 receives, from the mother store terminal, and outputs the replenishment date and time of the item based on the item request and the item stock in the mother store.

The item information acquisition unit 101 acquires the item ID and the item quantity of the item input by the customer at the child store, which has been transmitted by the input/output device 120, for example. The item information acquisition unit 101 passes the item ID and the item quantity to the request unit 102. The request unit 102 searches the item stock in the child store and confirms whether the item quantity can be covered by the quantity of the item stock in the child store. More specifically, the request unit 102 searches the stock DB 110 by the item ID, compares the item quantity with the quantity of the item stock in the child store, and sends the comparison result to the output unit 103.

When the comparison result indicates that the item quantity is equal to or less than the quantity of the item stock in the child store, the output unit 103 outputs, to the input/output device 120, a purchase notification indicating that the customer can purchase the item at the child store. The purchase notification is, for example, “You can make a purchase”. The purchase notification may be an audio purchase notification as long as it indicates that the item can be purchased at the child store.

When the comparison result indicates that the item quantity is more than the quantity of the item stock in the child store, the request unit 102 generates an item request and sends the item request to the mother store terminal 200 of the mother store. The item request generated by the request unit 102 includes the item ID of the item and the request quantity of the item. The request unit 102 calculates the request quantity based on the item quantity and the item stock in the child store. The request quantity represents a shortage of the quantity of the item stock in the child store with respect to the item quantity having been input by the customer.

For example, the request unit 102 may set the request quantity to be a quantity more than the difference between the item quantity and the quantity of item stock. This is to prevent the item from being out of stock in the child store due to the customer's purchase of the item replenished based on the item request. Alternatively, the request unit 102 may calculate the request quantity in consideration of the possibility that the quantity of item stock in the child store decreases during the period from the transmission of the item request to the replenishment of the item.

When the comparison result indicates that the item quantity is more than the quantity of the item stock in the child store, the output unit 103 receives the replenishment date and time of the item based on the item request and the item stock in the mother store from the mother store terminal 200 and outputs the replenishment date and time to the input/output device 120. The input/output device 120 outputs a message including the replenishment date and time. The message including the replenishment date and time of the item to be output is, for example, “Item A will arrive at 2 PM today”.

(Mother Store Terminal)

The mother store terminal 200 of the mother store acquires the replenishment date and time of the item for the item request based on the item request (item ID and request quantity) generated by the information processing device 100 of the child store and the item stock in the mother store, and transmits the replenishment date and time to the information processing device 100.

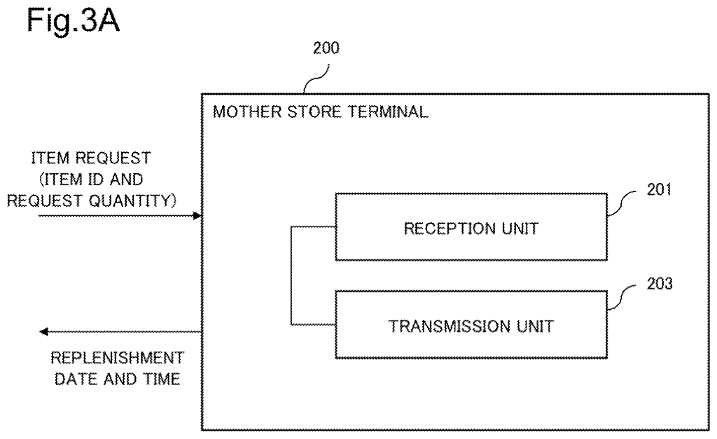

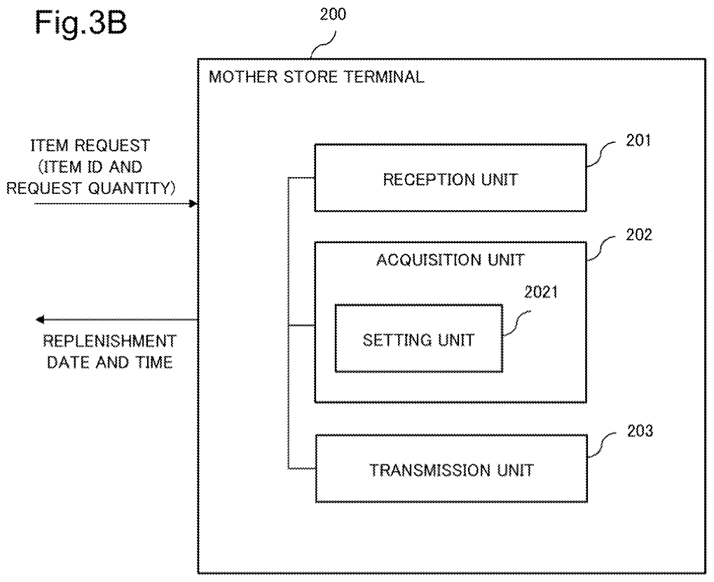

An outline of the mother store terminal according to the first example embodiment will be described with reference to the drawings. FIG. 3A is an outline diagram illustrating the outline of the mother store terminal according to the first example embodiment. The mother store terminal 200 illustrated in FIG. 3A includes a reception unit 201 and a transmission unit 203. The reception unit 201 receives, from the information processing device 100, the item request generated based on the item ID of an item input by the customer at the child store, the item quantity of the item, and the item stock in the child store. The transmission unit 203 transmits, to the information processing device 100, the replenishment date and time of the item based on the item request for the item input by the customer and the item stock in the mother store.

The configuration of the mother store terminal 200 will be described below in detail.

FIG. 3B is a block diagram illustrating an example of the configuration of the mother store terminal according to the first example embodiment. As illustrated in FIG. 3B, the mother store terminal 200 includes the reception unit 201, an acquisition unit 202, and the transmission unit 203. The acquisition unit 202 includes a setting unit 2021. The setting unit 2021 sets replenishment date and time for replenishing the item in the child store that has transmitted the item request.

The reception unit 201 receives the item request generated based on the item ID of an item input by the customer at the child store, the item quantity of the item, and the item stock in the child store. The reception unit 201 passes the item request to the acquisition unit 202. The acquisition unit 202 acquires the replenishment date and time of the item based on the item request for the item and the item stock in the mother store. More specifically, first, the acquisition unit 202 searches the item stock in the mother store regarding the item on the item request, and confirms whether the request quantity included in the item request can be covered by the quantity of the item stock in the mother store. More specifically, the acquisition unit 202 searches the stock DB 210 of the mother store by the item ID, and compares the request quantity on the item request with the quantity of the item stock in the mother store.

When the request quantity on the item request is equal to or less than the quantity of the item stock in the mother store, the acquisition unit 202 acquires the replenishment date and time of the item using the setting unit 2021. The replenishment date and time set by the setting unit 2021 is, for example, date and time in which a store clerk of a mother store regularly replenishes a child store with the item.

The replenishment date and time set by the setting unit 2021 may be other than the date and time for regular replenishment of the item, and if the store clerk of the mother store is available at the time of receiving the item request, the store clerk of the mother store may replenish the child store with the item on the item request. More specifically, in response to an instruction from the setting unit 2021, the transmission unit 203 of the mother store terminal 200 transmits, to the store clerk terminal 220, the received item request and the regular replenishment date and time, and notifies the store clerk of the mother store of the presence of the item request from the child store. The store clerk terminal 220 is, for example, a point of sale (POS) terminal or an arrival inspection terminal. If there is replenishment date and time when the store clerk of the mother store is able to replenish the child store with an item earlier than the date and time for regularly replenishing the child store with the item depending on his/her work situation at the time of receiving the notification, the store clerk registers the replenishment date and time into the store clerk terminal 220 and transmits the replenishment date and time to the mother store terminal 200. The setting unit 2021 sets, as the replenishment date and time, the date and time transmitted from the store clerk terminal 220.

When the request quantity on the item request is equal to or less than the quantity of the item stock in the mother store, the acquisition unit 202 acquires the replenishment date and time of the item from the setting unit 2021 and passes the replenishment date and time to the transmission unit 203. When the request quantity on the item request is more than the quantity of the item stock in the mother store, the setting unit 2021 sets the scheduled arrival date of the item as the replenishment date and time. The scheduled arrival date is the date on which the item is scheduled to arrive at the mother store from the distribution center. The scheduled arrival date is obtained by referring to, for example, an order delivery schedule of an order system (not illustrated) of the mother store.

The transmission unit 203 transmits, to the information processing device 100, the replenishment date and time of the item acquired by the acquisition unit 202 based on the result of comparing the request quantity on the item request with the quantity of the item stock in the mother store.

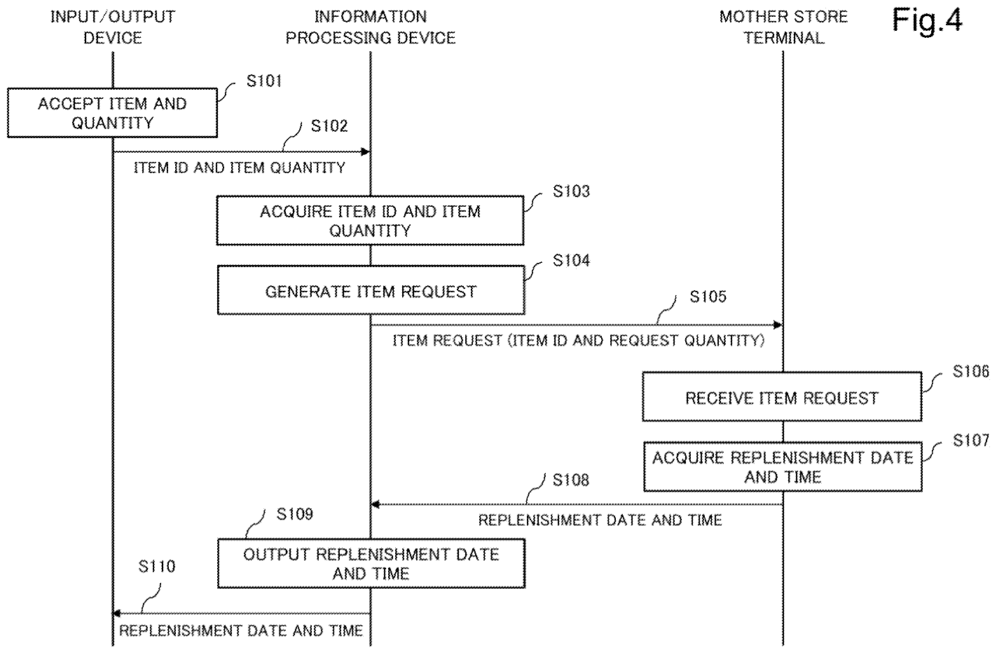

Next, the operation of the information processing system according to the first example embodiment will be described with reference to the drawings. FIG. 4 is a sequence diagram illustrating an example of the operation of the information processing system according to the first example embodiment.

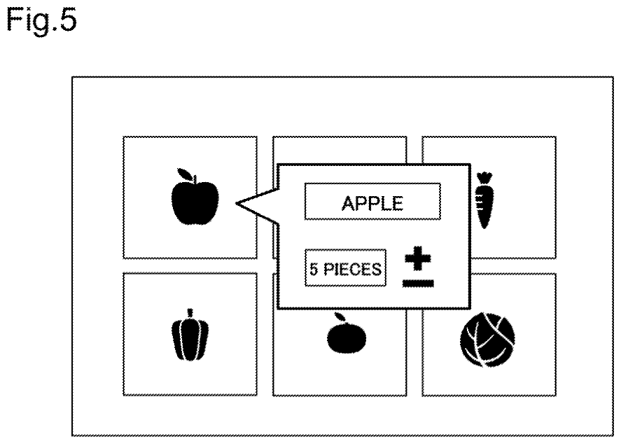

First, an input screen is displayed when the customer selects an item that he/she wants to purchase from among the items displayed on the input/output device 120 (touchscreen display) present in the child store. FIG. 5 is a view illustrating an example of the input screen on which the customer inputs an item and its quantity. The input screen illustrated in FIG. 5 displays an item name and quantity, and the quantity can be increased or decreased to a value desired by the customer by a button in the input screen. When the input of the item and quantity by the customer ends, the input/output device 120 accepts the item and quantity that the customer wants to purchase at the child store (step S101). The input/output device 120 transmits, to the information processing device 100, the item and quantity input by the customer, as the item ID and the item quantity (step S102).

The item information acquisition unit 101 of the information processing device 100 acquires the item ID and the item quantity of the item input by the customer at the child store, which has been transmitted by the input/output device 120 (S103). Subsequently, when the item quantity is more than the quantity of the item stock in the child store, the request unit 102 generates the item request based on the item ID, the item quantity, and the quantity of the item stock in the child store (step S104).

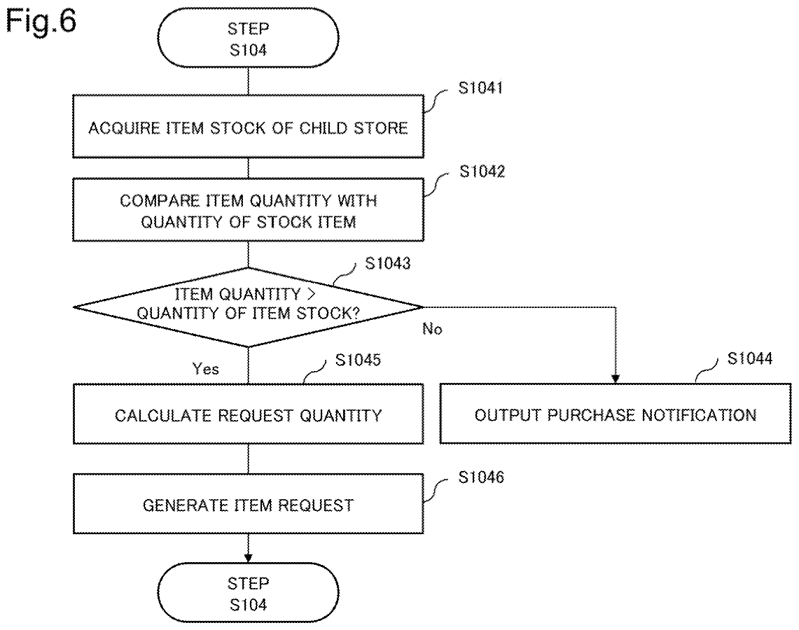

The details of the processing in step S104 will be described with reference to FIG. 6. The request unit 102 searches the stock DB 110 by the item ID, acquires the item stock in the child store (step S1041), and compares the item quantity with the quantity of the item stock in the child store (step S1042).

When the item quantity is equal to or less than the quantity of the item stock in the child store (No in step S1043), the request unit 102 outputs a purchase notification indicating that the customer can make a purchase at the child store (step S1044). In the case of No in step S1043, the following step S1045 to step S110 are not executed.

When the item quantity is more than the quantity of the item stock in the child store (Yes in step S1043), the request unit 102 calculates the request quantity based on the item quantity and the quantity of the item stock in the child store (step S1045). The request quantity represents a shortage of the quantity of the item stock in the child store with respect to the item quantity having been input by the customer. The request unit 102 generates the item request including the item ID of the item and the request quantity of the item (step S1046).

Returning to FIG. 4, the request unit 102 sends the generated item request to the mother store terminal 200 of the mother store (step S105).

Next, the reception unit 201 of the mother store terminal 200 receives the item request including the item ID and the request quantity (step S106). The acquisition unit 202 searches the stock DB 210 of the mother store by the received item ID, and compares the request quantity on the item request with the quantity of the item stock in the mother store.

When the request quantity on the item request is equal to or less than the quantity of the item stock in the mother store, the acquisition unit 202 acquires the replenishment date and time of the item set by the setting unit 2021 (step S107). The replenishment date and time is transmitted to the information processing device 100 (step S108). The replenishment date and time is, for example, date and time in which the store clerk of the mother store regularly replenishes the child store with the item.

The transmission unit 203 may transmit the item stock in the mother store to the information processing device 100 together with the replenishment date and time. By knowing the item stock in the mother store, the customer can purchase the item stock in the mother store early in addition to the item stock in the child store. Both the mother store and child store can increase sales opportunities.

The output unit 103 of the information processing device 100 receives the replenishment date and time of the item from the mother store terminal 200 and outputs the replenishment date and time to the input/output device 120 (step S109 and step S110).

Although the acquisition unit 202 of the mother store terminal 200 according to the first example embodiment confirms whether the request quantity included in the item request can be covered by the quantity of the item stock in the mother store, the acquisition unit 202 may acquire the item stock of another child store and confirm whether the request quantity included in the item request can be covered by the sum of the quantity of the item stock in the mother store and the quantity of the item stock of the another child store. More specifically, the acquisition unit 202 may search the stock DB 210 of the mother store and the stock DB 110 of another child store by the item ID, and compare the request quantity on the item request, the quantity of the item stock in the mother store, and the quantity of the item stock of the another child store. The replenishment date and time set by the setting unit 2021 of the acquisition unit 202 becomes the date and time in which the store clerk of the mother store replenishes the child store with the item via the another child store.

### Effects of First Example Embodiment

According to the first example embodiment, in the information processing device 100, the item information acquisition unit 101 acquires the item ID and the item quantity of an item input by the customer at the child store, and the request unit 102 generates an item request based on the item ID, the item quantity, and the item stock in the child store and transmits the item request to the mother store terminal 200. The output unit 103 receives, from the mother store terminal 200, and outputs the replenishment date and time of the item based on the item request and the item stock in the mother store. The information processing device 100 can notify the replenishment date and time of the item to the child store in consideration of the item stock in the mother store for the item that the customer wants to purchase and its quantity.

### Second Example Embodiment

The information processing system of the second example embodiment is assumed to be an example in which items are displayed on a display shelf installed in a child store and a customer inputs the item quantity he/she wants to purchase to an electronic shelf label installed for each item category of the display shelf. The display shelf is also called a display fixture. The display fixture is a store fixture for displaying items. The display fixture includes a display hook and a showcase, in addition to the display shelf.

The items of a store are sometimes stocked not only on the display shelf but also in another place in the store. The information processing device 100 of the second example embodiment generates the item request in consideration of the item quantity on the display shelf and the quantity of item stock in the child store.

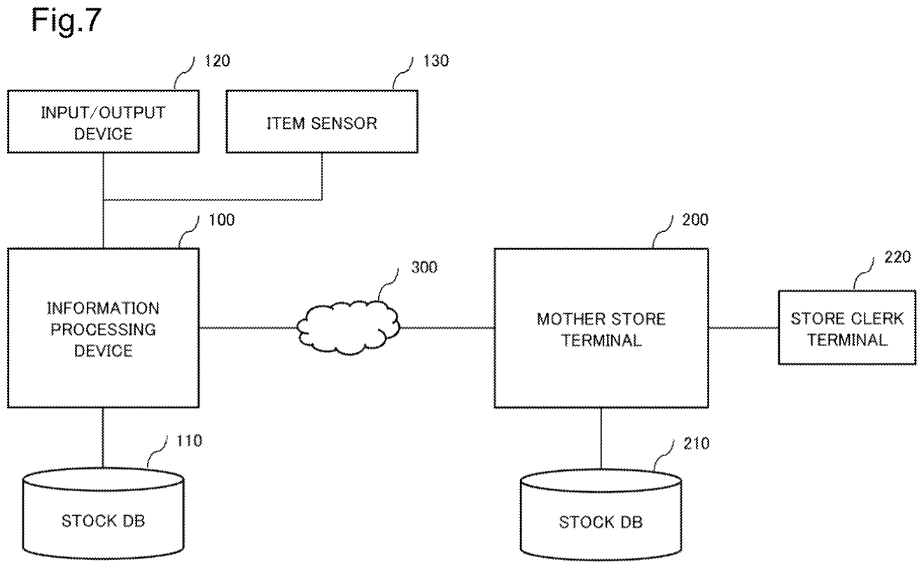

The information processing system, the information processing device, and the mother store terminal according to the second example embodiment will be described with reference to the drawings. FIG. 7 is a diagram illustrating an outline of the information processing system according to the second example embodiment. The information processing system illustrated in FIG. 7 is different from that of the first example embodiment in that the information processing system illustrated in FIG. 7 further includes an item sensor 130. The item sensor 130 is, for example, a camera that photographs items displayed on a display shelf of a child store. Alternatively, the item sensor 130 is a weight sensor that measures the weight of items in the same item category displayed on a display shelf of a child store. The stock DB 110, the mother store terminal 200, the stock DB 210, and the store clerk terminal 220 are the same as those of the first example embodiment, and hence descriptions are omitted. The input/output device 120 is assumed to be an electronic shelf label. For example, the customer looks at the item displayed on the display shelf, and when the quantity of the item on the display shelf is less than the quantity of the item he/she wants to purchase, he/she inputs, in the electronic shelf label, the quantity of the item he/she wants to purchase. The electronic shelf label is installed for each item category and associated with the item ID of the item. The input/output device 120 transmits, to the information processing device 100, the item ID and item quantity of the item input by the customer as in the first example embodiment.

Next, the information processing device according to the second example embodiment will be described with reference to the drawings. In the second example embodiment, the information processing device 100 further includes a detection unit. Hereinafter, in the description of the information processing device 100 of the second example embodiment, components same as those of the first example embodiment are denoted by the same reference numerals, and a detailed description will be omitted.

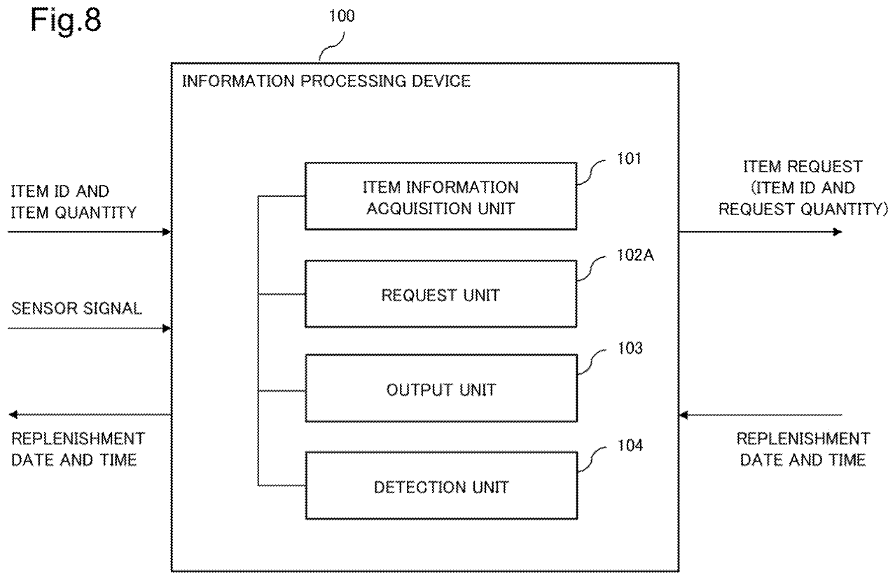

FIG. 8 is a block diagram illustrating an example of the configuration of the information processing device according to the second example embodiment. The information processing device 100 illustrated in FIG. 8 includes the item information acquisition unit 101, a request unit 102A, the output unit 103, and a detection unit 104. Since the item information acquisition unit 101 and the output unit 103 of the information processing device 100 according to the second example embodiment are the same as those of the first example embodiment, their description will not be repeated and the detection unit 104 and the request unit 102A will be described below.

The detection unit 104 accepts a sensor signal from the item sensor 130 and detects the quantity of the items in the same item category of the display shelf. For example, if the item sensor 130 is a camera and the sensor signal is image data of the item photographed by the camera, the detection unit 104 performs object recognition processing on the image data to detect the quantity of the items displayed in the same item category.

If the item sensor 130 is a weight scale and the sensor signal is a total weight of items in the same item category by the weight scale, the detection unit 104 detects the quantity of the items displayed in the same item category based on the weight of one item. Thus, the detection unit 104 sends the request unit 102A the quantity of the item detected on the display shelf, as the display quantity based on the sensor signal from the item sensor.

The request unit 102A accepts the display quantity of the item on the display shelf from the detection unit 104, and generates the item request based on the item ID of an item input by the customer, the item quantity of the item, the display quantity of the item on the display shelf, and the item stock in the child store. More specifically, the request unit 102A compares the display quantity of the item on the display shelf with the quantity of the item stock in the child store, and confirms whether the item is stocked other than on the display shelf. The display quantity shall not exceed the quantity of item stock.

When the comparison result indicates that the display quantity of the item and the quantity of the item stock in the child store are the same, the request unit 102A generates the item request based on the item ID of the item, the item quantity of the item, and the display quantity of the item.

On the other hand, when the comparison result indicates that the display quantity of the item is less than the quantity of the item stock in the child store, the item is stocked other than on the display shelf, and therefore the request unit 102A generates the item request based on the item ID of the item, the item quantity of the item, and the item stock in the child store.

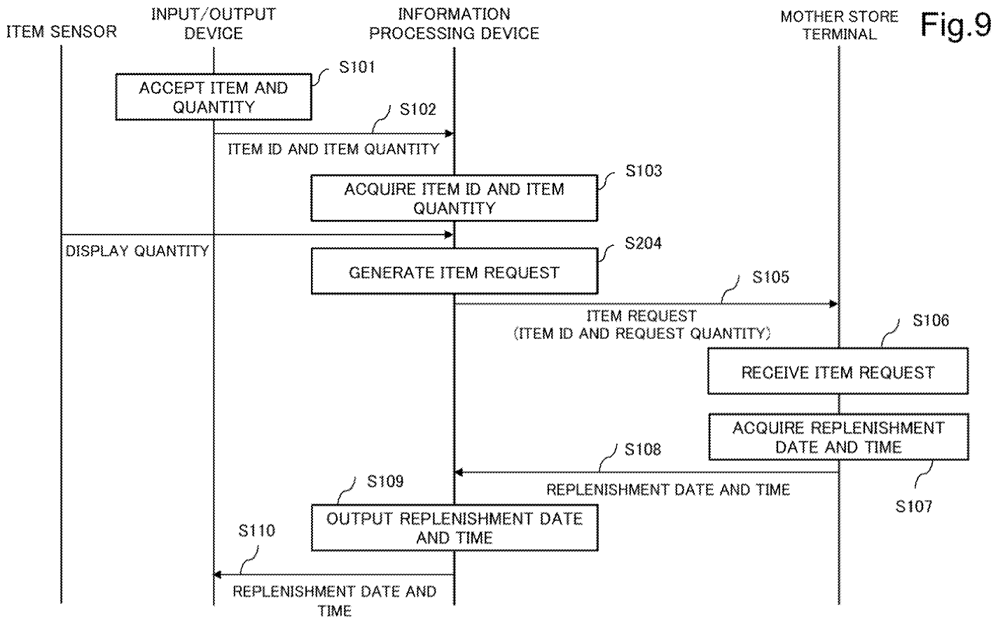

Next, the operation of the information processing system according to the second example embodiment will be described with reference to the drawings. FIG. 9 is a sequence diagram illustrating an example of the operation of the information processing system according to the second example embodiment. In the operation of the information processing system according to the second example embodiment illustrated in FIG. 9, “generate item request (step S104)” of the information processing device 100 in the operation of the first information processing system illustrated in FIG. 4 is replaced with “generate item request (step S204)”. There is a difference in that the display quantity is accepted from the item sensor 130 to the information processing device 100 before the information processing device 100 generates the item request in step S204.

The input/output device 120 in the second example embodiment is assumed to be an electronic shelf label installed on the display shelf. The electronic shelf label has an input screen, where the item name and quantity are displayed. The quantity can be increased or decreased to a value desired by the customer by a button in the input screen. When the input of the item and quantity made by the customer ends, similarly to the input/output device 120 of the first example embodiment, the input/output device 120 in the second example embodiment transmits to the information processing device 100, the item and quantity input by the customer, as the item ID and the item quantity (step S102).

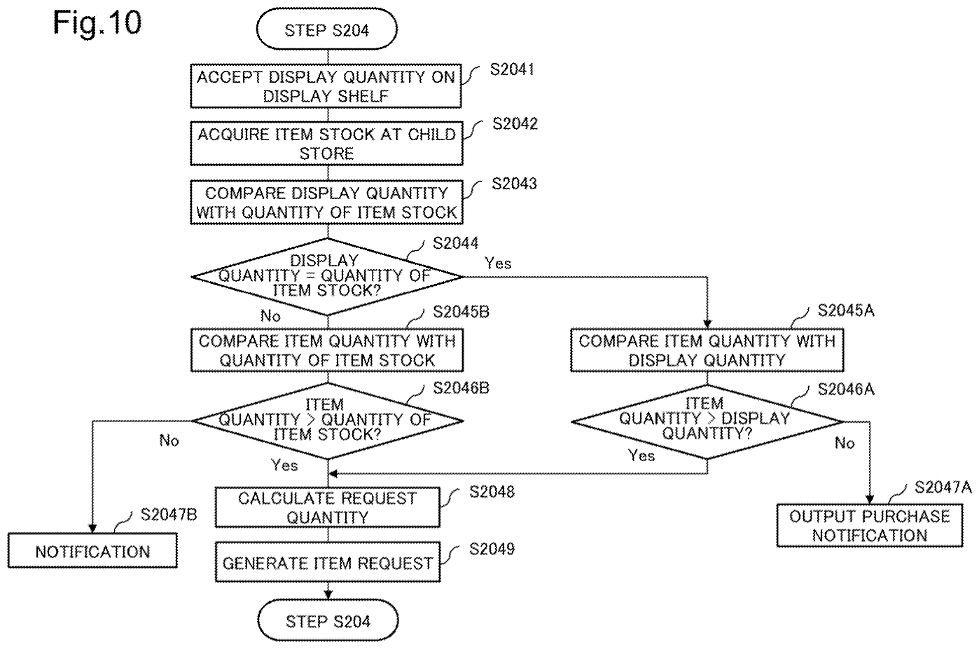

The details of the processing in step S204, which is a difference between the operation of the information processing device 100 of the second example embodiment and the operation of the information processing device 100 of the first example embodiment, will be described with reference to FIG. 10.

First, the request unit 102A confirms whether the item is stocked other than on the display shelf. More specifically, the request unit 102A accepts the display quantity of the item on the display shelf from the detection unit 104 (step S2041), acquires the item stock in the child store from the stock DB 110 (step S2042), and compares the display quantity of the item with the quantity of the item stock in the child store (step S2043).

When the comparison result indicates that the display quantity of the item and the quantity of the item stock in the child store are the same (Yes in step S2044), the request unit 102A generates the item request based on the item ID of the item, the item quantity of the item, and the quantity (display quantity) of the item stock in the child store. More specifically, the request unit 102 compares the item quantity of the item with the display quantity of the display shelf (step S2045A).

When the item quantity is equal to or less than the display quantity (No in step S2046A), the request unit 102A outputs a purchase notification indicating that the customer can purchase the item displayed on the display shelf (step S2047A).

On the other hand, when the item quantity is more than the display quantity (Yes in step S2046A), the request unit 102A calculates the request quantity based on the item quantity and the quantity (display quantity) of the item stock in the child store (step S2048). The request quantity represents a shortage of the display quantity of the item on the display shelf with respect to the item quantity having been input by the customer. The request unit 102A generates the item request including the item ID of the item and the request quantity of the item (step S2049).

On the other hand, when the comparison result indicates that the display quantity of the item is less than the quantity of the item stock in the child store (No in step S2044), the item is stocked other than on the display shelf, and therefore the request unit 102A generates the item request based on the item ID of the item, the item quantity of the item, and the quantity of the item stock in the child store. More specifically, the request unit 102A searches the stock DB 110 by the item ID and compares the item quantity with the quantity of the item stock in the child store (step S2045B).

When the item quantity is equal to or less than the quantity of the item stock in the child store (No in step S2046B), the request unit 102A outputs a purchase notification indicating that the customer can make a purchase at the child store (step S2047B). The notification that is output at this time is, for example, “We have a stock in the store as well as on to the display shelf. Please ask our store clerk”.

When the item quantity is more than the quantity of the item stock (Yes in step S2046B), the request unit 102A calculates the request quantity based on the item quantity and the quantity of the item stock in the child store (step S2048). The request quantity represents a shortage of the quantity of the item stock in the child store with respect to the item quantity having been input by the customer. The request unit 102A generates the item request including the item ID of the item and the request quantity of the item (step S2049).

### Effects of Second Example Embodiment

According to the second example embodiment, similarly to the first example embodiment, the information processing device 100 can notify the replenishment date and time of the item to the child store in consideration of the item stock in the mother store for the item that the customer wants to purchase and its quantity.

According to the second example embodiment, the information processing device 100 further includes the detection unit 104 that detects the display quantity of the item displayed on the display fixture in the child store, and the request unit 102A generates the item request based on the item ID, the item quantity, the display quantity of the item, and the quantity of the item stock in the child store. Since the information processing device 100 generates the item request in consideration of the quantity of the item on the display shelf and the item stock in the child store, the accuracy when generating the item request becomes high.

(Hardware Configuration)

In the above-described example embodiments, each component of the information processing device 100 and the mother store terminal 200 shows a block of a functional unit. Some or all of the components of each device may be achieved by a discretionary combination of a computer and a program.

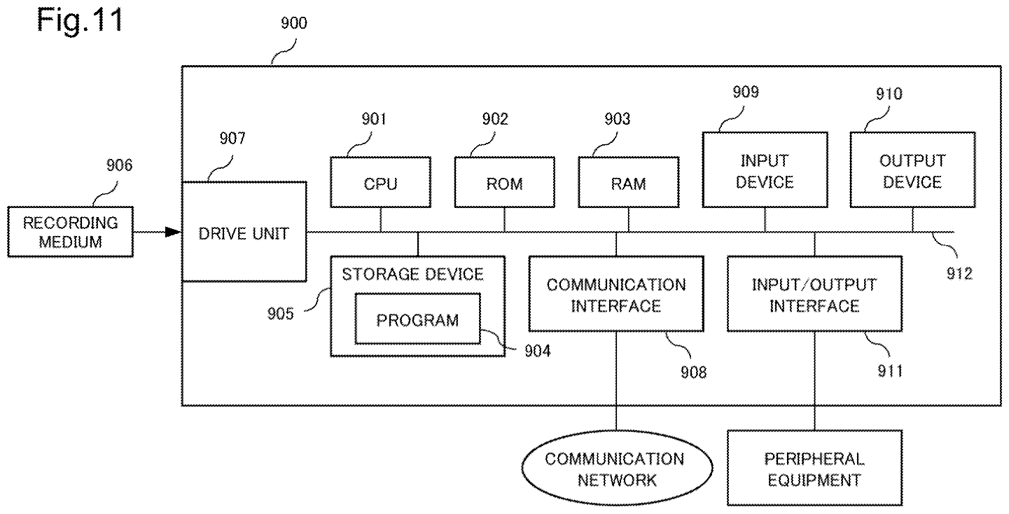

FIG. 11 is a block diagram illustrating an example of the hardware configuration of a computer. Referring to FIG. 11, a computer 900 includes, for example, a central processing unit (CPU) 901, a read only memory (ROM) 902, a random access memory (RAM) 903, a program 904, a storage device 905, a drive device 907, a communication interface 908, an input device 909, an output device 910, and a bus 912.

The program 904 includes an instruction for implementing the functions of the information processing device 100 and the mother store terminal 200. The program 904 is stored in the ROM 902, the RAM 903, and the storage device 905 in advance. The CPU 901 implements the functions of the information processing device 100 and the mother store terminal 200 by executing an instruction included in the program 904.

For example, the CPU 901 of the information processing device 100 executes an instruction included in the program 904 to implement the function of the configuration. The RAM 903 may temporarily store data to be processed in the functions of the information processing device 100 and the mother store terminal 200.

The drive device 907 reads and writes a recording medium 906. The communication interface 908 provides an interface with a communication network. The input device 909 is, for example, a mouse, a keyboard, or the like, and accepts input of information from the customer or the like. The output device 910 is, for example, a display, and outputs (displays) information to the customer or the like. The input/output interface 911 provides an interface with peripheral equipment. In the case of the information processing device 100, a camera, a barcode reader, a tag reader/writer, and a card reader/writer may be connected to the input/output interface 911. The bus 912 connects the components of these pieces of hardware. The program 904 may be supplied to the CPU 901 via the communication network, or may be stored in the recording medium 906 in advance, read by the drive device 907, and supplied to the CPU 901.

The hardware configuration illustrated in FIG. 11 is an example, and components other than these may be added, or some components may not be included.

There are various modifications of the achievement method of each device. For example, each device may be achieved by a discretionary combination of a computer and a program different for each component. A plurality of components included in each device may be achieved by a discretionary combination of a computer and a program.

Also, some or all of the components of each device may be achieved by a general-purpose or special-purpose circuitry including a processor, or a combination thereof. These circuitries may be configured by a single chip or may be configured by a plurality of chips connected via the bus. Some or all of the components of each device may be achieved by a combination of the above-described circuitry and program.

When some or all of the components of each device are achieved by a plurality of computers, circuitries, and the like, the plurality of computers, circuitries, and the like may be centralized or decentralized.

In each example embodiment, the steps describing the series of processing described above include not only processing performed in time series in accordance with the order as described, but also processing executed in parallel or individually even if not necessarily performed in time series.

The present disclosure is not limited to the above-described example embodiments and various modifications can be made, and example embodiments obtained by appropriately combining the configurations, operations, and processing disclosed in the different example embodiments are also included in the technical scope of the present disclosure.

While the invention has been particularly shown and described with reference to exemplary example embodiments thereof, the disclosure is not limited to these example embodiments. It will be understood by those of ordinary skill in the art that various modes in example embodiments in the present disclosure may be applied therein without departing from the spirit and scope of the present disclosure as defined by the claims.

This application is based upon and claims the benefit of priority from Japanese patent application No. 2019-054691, filed on Mar. 22, 2019, the disclosure of which is incorporated herein in its entirety by reference.

A part or the entirety of the above example embodiments can be described as the following supplementary notes, but are not limited to the following.

(Supplementary Note 1)

An information processing device of a child store communicably connected to a mother store terminal of a mother store, the information processing device including:

an item information acquisition means for acquiring an item ID and an item quantity of an item input by a customer at the child store;

a request means for generating an item request based on the item ID, the item quantity, and an item stock in the child store and transmitting the item request to the mother store terminal; and an output means for receiving, from the mother store terminal, and outputting replenishment date and time of the item, based on the item request and an item stock in the mother store.

(Supplementary Note 2)

The information processing device according to supplementary note 1, in which the item request having been generated includes a request quantity calculated based on an item stock in the child store and the item quantity.

(Supplementary Note 3)

The information processing device according to supplementary note 2, in which the request means generates the item request by setting the request quantity to be a quantity more than a difference between the item quantity and the item stock.

(Supplementary Note 4)

The information processing device according to any one of supplementary notes 1 to 3 further including a detection means for detecting a display quantity of the item displayed on a display fixture in the child store, in which the request means generates the item request based on the item quantity, the display quantity of the item, and an item stock in the child store.

(Supplementary Note 5)

A mother store terminal of a mother store communicably connected to an information processing device of a child store, the mother store terminal including:

a reception means for receiving, from the information processing device, an item request generated based on an item ID of an item input by a customer at the child store, an item quantity of the item, and an item stock in the child store; and a transmission means for transmitting, to the information processing device, replenishment date and time of the item based on the item request for the item and an item stock in the mother store.

(Supplementary Note 6)

The mother store terminal according to supplementary note 5, in which when an item stock in the mother store is more than a request quantity of the item, the transmission means transmits, to the information processing device, replenishment date and time in which a store clerk of the mother store replenishes the child store with the item on the item request.

(Supplementary Note 7)

The mother store terminal according to supplementary note 5 or 6, in which when an item stock in another child store is more than a request quantity included in the item request, the transmission means transmits, to the information processing device, the replenishment date and time in which a store clerk of the mother store moves the item on the item request, from the another child store to the child store, for replenishment.

(Supplementary Note 8)

An information processing system in which a mother store terminal of a mother store and an information processing device of a child store are communicably connected, in which

the information processing device includes

an item information acquisition means for acquiring an item ID and an item quantity of an item input by a customer at the child store,

a request means for generating an item request based on the item ID, the item quantity, and an item stock in the child store and transmitting the item request to the mother store terminal, and

an output means for receiving, from the mother store terminal, and outputting replenishment date and time of the item, and

the mother store terminal includes

a reception means for receiving, from the information processing device, the item request generated, and

a transmission means for transmitting, to the information processing device, the replenishment date and time based on the item request and an item stock in the mother store.

(Supplementary Note 9)

An information processing method of an information processing device of a child store communicably connected to a mother store terminal of a mother store, the information processing method including:

acquiring an item ID and an item quantity of an item input by a customer at the child store;

generating an item request based on the item ID, the item quantity, and an item stock in the child store and transmitting the item request to the mother store terminal; and

receiving, from the mother store terminal, and outputting replenishment date and time of the item based on the item request and an item stock in the mother store.

(Supplementary Note 10)

A program of an information processing device of a child store communicably connected to a mother store terminal of a mother store, the program causing

the information processing device to function as

an item information acquisition means for acquiring an item ID and an item quantity of an item input by a customer at the child store;

a request means for generating an item request based on the item ID, the item quantity, and an item stock in the child store and transmitting the item request to the mother store terminal; and

an output means for receiving, from the mother store terminal, and outputting replenishment date and time of the item based on the item request and an item stock in the mother store.

### REFERENCE SIGNS LIST

100 information processing device
101 item information acquisition unit
102, 102A request unit
1021 calculation unit
103 output unit
104 detection unit
110 stock DB
120 input/output device
130 item sensor
200 mother store terminal
201 reception unit
202 acquisition unit
2021 setting unit
203 transmission unit
210 stock DB
220 store clerk terminal
300 network
900 computer
901 CPU
902 ROM
903 RAM
904 program
905 storage device

What is claimed is:

1. An information processing device of a child store communicably connected to a mother store terminal of a mother store, the information processing device comprising:
at least one memory configured to store instructions; and
at least one processor configured to execute the instructions to:
acquire an item ID and an item quantity of an item input by a customer at the child store;
generate an item request based on the item ID, the item quantity, and an item stock in the child store;
transmit the item request to the mother store terminal;
receive, from the mother store terminal, replenishment date and time of the item, determined based on the item request and an item stock in the mother store; and
output the replenishment date and time of the item.

2. The information processing device according to claim 1, wherein the at least one processor is further configured to execute the instructions to:
generate the item request to include a request quantity calculated based on the item stock in the child store and the item quantity.

3. The information processing device according to according to 2, wherein the at least one processor is further configured to execute the instructions to:
generate the item request by setting the request quantity to be a quantity more than a difference between the item quantity and the item stock in the child store.

4. The information processing device according to claim 1, wherein the at least one processor is further configured to execute the instructions to:
detect a display quantity of the item displayed on a display fixture in the child store; and
generate the item request based on the item quantity, the display quantity of the item, and the item stock in the child store.

5.-8. (canceled)

9. An information processing method of an information processing device of a child store communicably connected to a mother store terminal of a mother store, the information processing method comprising:
acquiring an item ID and an item quantity of an item input by a customer at the child store;
generating an item request based on the item ID, the item quantity, and an item stock in the child store and transmitting the item request to the mother store terminal; and
receiving, from the mother store terminal, and outputting replenishment date and time of the item based on the item request and an item stock in the mother store.

10. A non-transitory computer-readable recording medium storing a program of an information processing device of a child store communicably connected to a mother store terminal of a mother store, the program causing
the information processing device to function as
an item information acquisition means for acquiring an item ID and an item quantity of an item input by a customer at the child store;
a request means for generating an item request based on the item ID, the item quantity, and an item stock in the child store and transmitting the item request to the mother store terminal; and
an output means for receiving, from the mother store terminal, and outputting replenishment date and time of the item based on the item request and an item stock in the mother store.

11. The information processing device according to claim 1, wherein the replenishment date and time represent when a store clerk of the mother store replenishes the child store with the item on the item request.

12. The information processing device according to claim 2, wherein the at least one processor is further configured to:
receive, when an item stock in the mother store is more than a request quantity of the item, the replenishment date and time.

13. The information processing device according to claim 2, wherein the at least one processor is further configured to:
receive the replenishment date and time in which a store clerk of the mother store moves the item on the item request, from the another child store to the child store, for replenishment, when an item stock in another child store is more than a request quantity included in the item request.

14. The information processing device according to claim 2, wherein the at least one processor is further configured to:
detect a display quantity of the item displayed on a display fixture in the child store; and
generate the item request based on the item quantity, the display quantity of the item, and the item stock in the child store.

15. The information processing device according to claim 3, wherein the at least one processor is further configured to:
detect a display quantity of the item displayed on a display fixture in the child store; and
generate the item request based on the item quantity, the display quantity of the item, and the item stock in the child store.
